(19) United States
(12) Patent Application Publication
(10) Pub. No.: US 2022/0330211 A1
(43) Pub. Date: Oct. 13, 2022

(54) COMMUNICATIONS DEVICE, INFRASTRUCTURE EQUIPMENT AND METHODS

(71) Applicant: Sony Group Corporation, Tokyo (JP)

(72) Inventors: Yassin Aden AWAD, Basingstoke (GB); Vivek SHARMA, Basingstoke (GB); Samuel Asangbeng ATUNGSIRI, Basingstoke (GB); Yuxin WEI, Basingstoke (GB); Hideji WAKABAYASHI, Basingstoke (GB)

(73) Assignee: Sony Group Corporation, Tokyo (JP)

(21) Appl. No.: 17/633,965

(22) PCT Filed: Sep. 21, 2020
(86) PCT No.: PCT/EP2020/076329

§ 371 Date: Feb. 9, 2022

(30) Foreign Application Priority Data
Sep. 27, 2019 (EP) 19200292.1

(51) Int. Cl. H04W 72/04; H04L 5/00; H04W 74/08; H04W 74/00

(52) U.S. Cl. CPC H04W 72/042; H04L 5/0048; H04W 74/0833; H04L 5/0055; H04W 74/004; H04W 72/044

(57) ABSTRACT

A method of operating a communications device in a wireless communications network, the method comprising: transmitting a random access message on a wireless access interface, the random access message comprising a selected random access preamble and a transmission on a shared channel, the shared channel transmission using a demodulation reference signal (DMRS) in accordance with one or more selected DMRS parameters, receiving a resource allocation message, the resource allocation message comprising an indication that the resource allocation message was transmitted in response to a random access message and an indication of downlink communications resources allocated for the transmission of a random access response message, receiving signals transmitted using the allocated downlink communications resources, determining that the resource allocation message identifies the communications device, and in response to determining that the resource allocation message identifies the communications device, decoding the signals transmitted using the allocated downlink communications resources.

### BACKGROUND

### Field

The present disclosure relates to communications devices, infrastructure equipment and methods for the reception of data by a communications device in a wireless communications network.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will be expected to support communications routinely and efficiently with a wider range of devices associated with a wider range of data traffic profiles and types than current systems are optimised to support. For example it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems [1], as well as future iterations/releases of existing systems, to efficiently support connectivity for a wide range of devices associated with different applications and different characteristic data traffic profiles.

An example of such a new service is referred to as Ultra Reliable Low Latency Communications (URLLC) services which, as its name suggests, requires that a data unit or packet be communicated with a high reliability and with a low communications delay. URLLC type services therefore represent a challenging example for both LTE type communications systems and 5G/NR communications systems.

The increasing use of different types of communications devices associated with different traffic profiles gives rise to new challenges for efficiently handling communications in wireless telecommunications systems that need to be addressed. This application claims the priority of European Patent Application EP19200292, the contents of which are hereby incorporated by reference in their entirety.

### SUMMARY

The present disclosure can help address or mitigate at least some of the issues discussed above.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured in accordance with example embodiments;

FIG. 4 shows a typical 4-step RACH procedure used in LTE systems;

FIG. 5 shows a typical 2-step RACH procedure;

FIG. 6 illustrates a message sequence chart showing transmissions by a base station and communication devices in accordance with the embodiments of the present technique;

FIG. 7 illustrates a process flow chart for a process carried out by a communications device in accordance with embodiments of the present technique; and

FIG. 8 illustrates a process for a base station in accordance with embodiments of the present technique.

### DETAILED DESCRIPTION OF THE EMBODIMENTS

Long Term Evolution Advanced Radio Access Technology (4G)

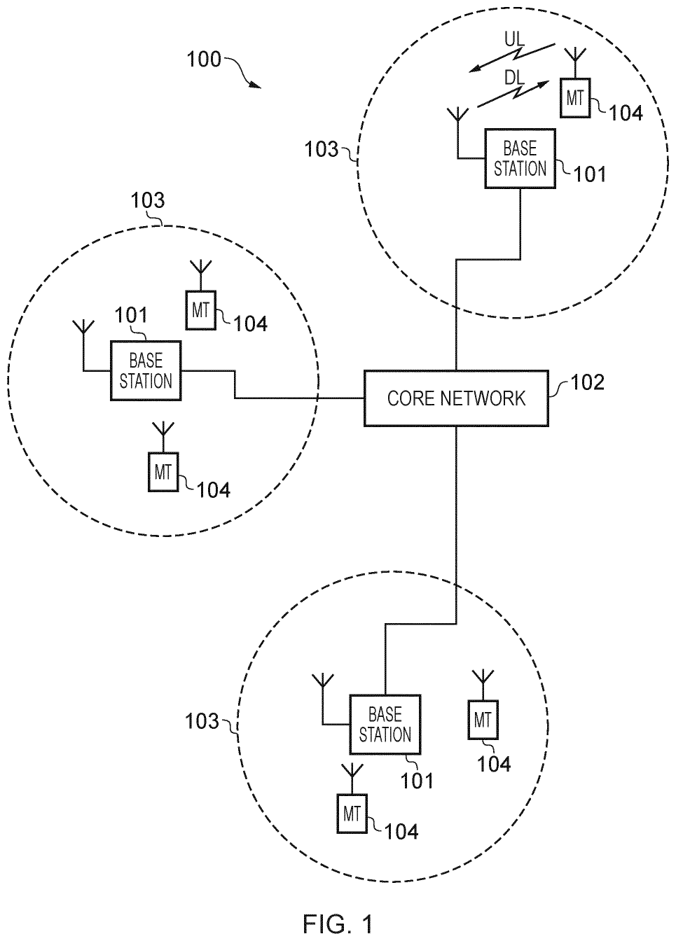

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs, g-nodeBs (gNB) and so forth. In this regard different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

New Radio Access Technology (5G)

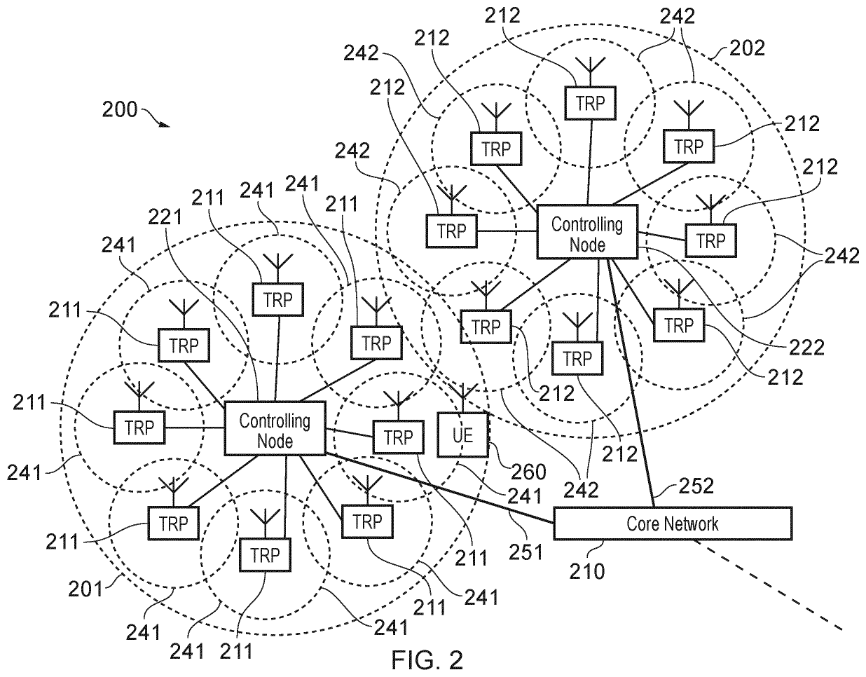

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs. A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated that in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated that the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

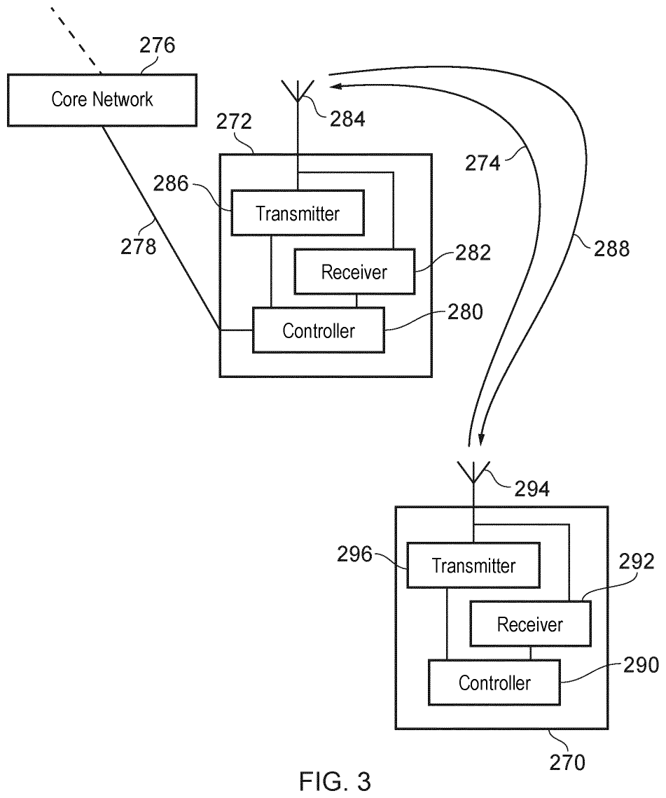

A more detailed illustration of a UE/communications device 270 (which may correspond to a communications device such as the communications device 260 of FIG. 2 or the communications device 104 of FIG. 1) and an example network infrastructure equipment 272, which may be thought of as a gNB 101 or a combination of a controlling node 221 and TRP 211, is presented in FIG. 3. As shown in FIG. 3, the UE 270 is shown to transmit uplink data to the infrastructure equipment 272 via uplink resources of a wireless access interface as illustrated generally by an arrow 274 from the UE 270 to the infrastructure equipment 272. The UE 270 may similarly be configured to receive downlink data transmitted by the infrastructure equipment 272 via downlink resources as indicated by an arrow 288 from the infrastructure equipment 272 to the UE 270. As with FIGS. 1 and 2, the infrastructure equipment 272 is connected to a core network 276 via an interface 278 to a controller 280 of the infrastructure equipment 272. The infrastructure equipment 272 includes a receiver 282 connected to an antenna 284 and a transmitter 286 connected to the antenna 284. Correspondingly, the UE 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the UE 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

5G, URLLC and Industrial Internet of Things

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable & Low Latency Communications (URLLC) services are for a reliability of 1-10⁻⁵ (99.999%) or higher for one transmission of a 32 byte packet with a user plane latency of 1 ms [3]. In some scenarios, there may be a requirement for a reliability of 1-10⁻⁶ (99.9999%) or higher with either 0.5 ms or 1 ms of user plane latency. Massive Machine Type Communications (mMTC) is another example of a service which may be supported by NR-based communications networks.

In addition, systems may be expected to support further enhancements related to Industrial Internet of Things (IIoT) in order to support services with new requirements of high availability, high reliability, low latency, and in some cases, high-accuracy positioning.

Industrial automation, energy power distribution and intelligent transport systems are examples of new use cases for Industrial Internet of Things (IIoT). In an example of industrial automation, the system may involve different distributed components working together. These components may include sensors, virtualized hardware controllers and autonomous robots, which may be capable of initiating actions or reacting to critical events occurring within a factory and communicating over a local area network.

The UEs in the network may therefore be expected to handle a mixture of different traffic, for example, associated with different applications and potentially different quality of service requirements (such as maximum latency, reliability, packet sizes, throughput). Some messages for transmission may be time sensitive and be associated with strict deadlines and the communications network may therefore be required to provide time sensitive networking (TSN) [6].

URLLC services are required in order to meet the requirements for IIoT, which require high availability, high reliability, low latency, and in some cases, high-accuracy positioning [1]. Some IIoT services may be implemented by using a mixture of eMBB and URLLC techniques, where some data is transmitted by eMBB and other data is transmitted by URLLC.

Conventional 4-step RACH

In wireless telecommunications networks, such as LTE type networks, there are different Radio Resource Control (RRC) modes for terminal devices. For example, it is common to support an RRC idle mode (RRC_IDLE) and an RRC connected mode (RRC_CONNECTED). A terminal device in the idle mode may transition to connected mode, for example because it needs to transmit uplink data or respond to a paging request, by undertaking a random access procedure. The random access procedure involves the terminal device transmitting a preamble on a physical random access channel and so the procedure is commonly referred to as a RACH or PRACH procedure/process.

In addition to a terminal device deciding itself to initiate a random access procedure to connect to the network, it is also possible for the network, e.g. a base station, to instruct a terminal device in connected mode to initiate a random access procedure by transmitting to the terminal device an instruction to do so. Such an instruction is sometimes referred to as a PDCCH order (Physical Downlink Control Channel order), see, for example, Section 5.3.3.1.3 in ETSI TS 136 213 V13.0.0 (2016-01)/3GPP TS 36.212 version 13.0.0 Release 13 [7]. There are various scenarios in which a network triggered RACH procedure (PDCCH order) may arise.

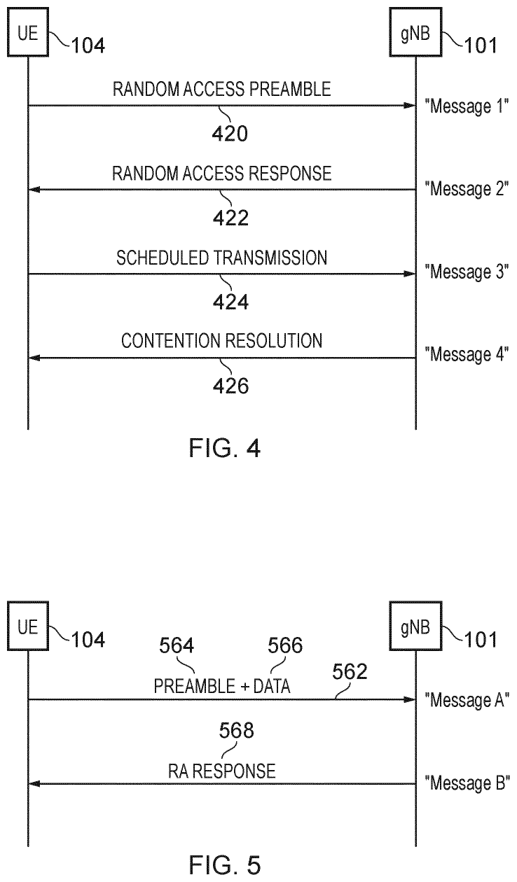

FIG. 4 shows a typical RACH procedure used in LTE systems such as that described by reference to FIG. 1 which could also be applied to an NR wireless communications system such as that described by reference to FIG. 2. A communications device (or UE) 104, which could be in an inactive or idle mode, may have some data which it needs to send to the network. To do so, the UE sends a random access preamble 420 (message 1) to a gNodeB 101. This random access preamble 420 indicates the identity of the communications device 104 to the gNodeB 101, such that the gNodeB 101 can address the communications device 104 during later stages of the RACH procedure. Assuming the random access preamble 420 is successfully received by the gNodeB 101, the gNodeB 101 will transmit a random access response 422 message (message 2) to the communications device 104 based on the identity indicated in the received random access preamble 420. The random access response 422 message carries a further identity which is assigned by the gNodeB 101 to identify the communications device 104, as well as a timing advance value (such that the communications device 104 can change its timing to compensate for the round trip delay caused by its distance from the gNodeB 101) and grant uplink resources for the communications device 104 to transmit the data in.

Following the reception of the random access response message 422, the communications device 104 transmits the scheduled transmission of data 424 to the gNodeB 101 (message 3), using the identity assigned to it in the random access response message 422. Assuming there are no collisions with other UEs, which may occur if another UE and the communications device 104 send the same random access preamble 420 to the gNodeB 101 at the same time and using the same frequency resources, the scheduled transmission of data 424 is successfully received by the gNodeB 101. The gNodeB 101 will respond to the scheduled transmission 424 with a contention resolution message 426 (message 4).

In 5G/NR systems, an “inactive” RRC state may be used, where a UE is able to start data transfer with a low delay in the inactive state without transition to a connected state. Various possible solutions have been proposed to permit this.

2-Step RACH Procedure

A development to transmit data more quickly for particular applications is known as a 2-step RACH [10].

As will be appreciated, compared with the 4-step RACH process, the 2-step RACH process can provide a facility for transmitting data more quickly. Accordingly it has been proposed to develop general MAC procedures covering both physical layer and higher layer aspects for the 2-step RACH process. In general, the benefit of the 2-step RACH procedure compared with the 4-step ACH procedure is to reduce the time it takes for connection setup/resume procedure. For example in an ideal situation the 2-step RACH will reduce the latency by halving the number of steps from 4 to 2 for initial access UEs. In addition, it is considered that a 2-step RACH procedure has potential benefits for channel access in NR unlicensed spectrum (NR-U) (see e.g. [11]).

Broadly, the 2-step RACH allows the combination of the transmission of the random access preamble 420 with the transmission of data 424 of FIG. 4 as an initial transmission (“Message A” or “MsgA”), and similarly the combination of the transmission of the random access response 422 and contention resolution message 426 as a response (“Message B”, or “MsgB”).

A fallback procedure may be provided to allow a RACH procedure which is started according to the specifications for a 2-step RACH to instead proceed according to the 4-step RACH procedure. 2-step RACH may be applicable for communications devices in the RRC_INACTIVE , RRC_CONNECTED and RRC_IDLE states.

A message flow diagram illustrating the 2-step RACH process is shown in FIG. 5. As its name suggests, in the 2-step RACH process, there are only two steps as follows:

1. The UE 201 transmits a Message A 562 which comprises a RACH preamble 564 and data (on a shared uplink channel, such as a physical uplink shared channel, PUSCH) 566 that in a 4-step RACH procedure would be transmitted in Message 3. More specifically the choice of a particular preamble may pre-configure the communications device 104 to transmit the data in pre-configured resources of the uplink shared channel as explained below.

2. The base station 101 having successfully received the Message A 562 responds with a Message B 568 which incorporates both a RAR (message 2) of the 4-step RACH procedure and the corresponding data (PDSCH) that in a 4-step RACH procedure would be transmitted in Message 4.

Downlink control information

Downlink messages (i.e. messages transmitted by the base station 102), such as the Message B or the Message 2, may be preceded by a transmission of downlink control information (DCI) as a resource allocation message to indicate downlink communications resources on which the downlink message is to be transmitted.

A communications device which has recently transmitted either a Message A or a random access request may therefore monitor a downlink control channel on which the DCI may be transmitted. The communications device may determine that the DCI allocates resources for a message transmitted as part of the RACH procedure based on a temporary identity used to encode the DCI. For example, the DCI may be encoded using a random access radio network temporary identity (RA-RNTI), specifically pre-allocated for the purpose of encoding a DCI which allocates resources for a random access response (RAR) message.

If the communications device detects that a DCI has been encoded using the RA-RNTI, then it may proceed to attempt to decode signals transmitted using the communications resources allocated by the DCI to recover the random access response message (e.g. Message B or Message 2).

UE Identity in RACH Procedure

During the RACH procedure (either 2-step or 4-step), various means may be made to identify a communications device, to avoid the possibility that a communications device considers that a downlink message was intended for it, when in fact the message was intended for (or was in response to) a different communications device.

For example, in a random access response in the 4-step procedure, the UE identity may comprise an index associated with the preamble used in the random access request. Thus, where two communications devices transmit a random access preamble at the same time, using the same frequency resources, but have selected different preambles, it is possible to determine the communications device to which the random access response is directed.

In the 2-step RACH procedure, a further UE identity may be used to encode the DCI which allocates resources for the Message B. For example, instead of the RA-RNTI described above, the DCI may be encoded using a “MsgB-RNTI”, which is derived based on time and frequency resources used for the MsgA transmission. For example, as set out in [5] the MsgB-RNTI may be determined as:
MsgB-RNTI=1+s_id+
   14×t_id+
   14×80×f_id+
   14×80×8+ul_carrier_id

where s_id is the index of the first OFDM symbol of the PRACH occasion (0≤s_id<14), t_id is the index of the first slot of the PRACH occasion in a system frame (0<t_id<80), where the subcarrier spacing to determine t_id is based on the value ofμ specified in subclause 5.3.2 in 3GPP TS 38.211 [12], f_id is the index of the PRACH occasion in the frequency domain (0<f_id<8), and ul_carrier_id is the UL carrier used for Random Access Preamble transmission (0 for NUL carrier, and 1 for SUL carrier).

Thus, a communications device receiving a DCI after transmitting a MsgA may decode the allocated downlink resources indicated in the DCI only if the RNTI of the DCI matches the MsgB-RNTI value calculated in accordance with the transmission by the communications device of the random access request.

It will be appreciated that although the MsgB-RNTI may be considered as an identity of a communications device, the MsgB-RNTI cannot guarantee that a particular communications device is thereby uniquely identified, since multiple communications devices may have transmitted random access preambles using communications resources which result in the same MsgB-RNTI value.

In the 2-step procedure, contention resolution is completed after the receipt of the MsgB. This is because the MsgA comprises not only a random access preamble, but also a temporary identity. The temporary identity may be locally unique and assigned by the communications network, for example by the base station 101, and may be a cell-RNTI (C-RNTI).

If the communications device does not have a valid C-RNTI, then it may generate a random RNTI value, which is included in the MsgA.

In any case, a random access response (RAR) comprises the identity included by the UE in the MsgA. Even if the UE identity is a random value, the probability of collision is very low, such that with a very high probability, only one communications device will consider the RAR to be addressed to it.

In order to improve the efficient use of communications resources in transmitting random access response (RAR) messages, responses to multiple random access request messages may be combined within a single MsgB. The multiple RAR messages may be directed to different communications devices. It may be a requirement that the MsgB-RNTI is valid for each of the MsgAs to which the multiple RAR messages are responding For example, multiple RAR messages may be combined within a single MsgB only if the sets of parameters s_id, t_id, f_id and ul_carrier_id associated with each MsgA to which a RAR message is a response are the same.

By contrast, in some scenarios, the MsgB may comprise a message comprising data which requires reliable delivery to the recipient communications device. For example, the data may be a radio resource configuration (RRC) message directed to a communications device, the RRC message being associated with a signalling radio bearer (SRB). It has been proposed to permit the use of a hybrid automatic repeat request (HARQ) process to provide for the transmission of acknowledgement information, and subsequent retransmissions of the data, if needed. Thus, in order to ensure reliable delivery, acknowledgement information may be transmitted in respect of the data and, if the acknowledgement information indicates that the data was not successfully received, the data may be retransmitted one or more further times, as necessary.

However, a consequence of using HARQ is that it is not possible to multiplex, in a single MsgB, any other RAR with data requiring reliable delivery.

It has further been recognised that multiple communications devices may simultaneously be in a state where a MsgA has been transmitted, but no RAR has been received. In accordance with current techniques, these communications devices must decode each MsgB whose DCI is encoded with a MsgB-RNTI which matches the parameters used for the transmission of their MsgA. This may result in unnecessary decoding steps for a communications device if in fact a decoded MsgB does not comprise a RAR which is in response to the MsgA transmitted by that communications device, even though the associated DCI had a ‘valid’ MsgB-RNTI corresponding to the MsgA.

There is thus a need to ensure that data can be reliably transmitted by means of the MsgB (second message) in a two-step RACH procedure and that a communications device can efficiently receive a MsgB comprising a RAR which is in response to a MsgA sent by that communications device.

Embodiments of the present technique can provide a method of operating a communications device in a wireless communications network, the method comprising: transmitting a random access message on a wireless access interface, the random access message comprising a selected random access preamble and a transmission on a shared channel, the shared channel transmission using a demodulation reference signal (DMRS) in accordance with one or more selected DMRS parameters, and receiving a resource allocation message, the resource allocation message comprising an indication that the resource allocation message was transmitted in response to a random access message and an indication of downlink communications resources allocated for the transmission of a random access response message. The method further comprises receiving signals transmitted using the allocated downlink communications resources, determining that the resource allocation message identifies the communications device, and in response to determining that the resource allocation message identifies the communications device, decoding the signals transmitted using the allocated downlink communications resources, wherein the resource allocation message comprises an indication of the identity of the communications device based on one or more of an index associated with the selected random access preamble and the one or more selected DMRS parameters.

Some embodiments of the present technique provide for an indication in the resource allocation message that acknowledgement information is to be transmitted by the communications device, indicating the received status of the data to be transmitted using the allocated resources. Thus, even if the communications device fails to decode the data, it is aware of the request to transmit acknowledgement information. The communications device also is made aware of the possibility of a retransmission of the data, and may thus determine to store soft-decoded bits generated in the unsuccessful decoding attempt, for use in decoding a subsequent retransmission of the data.

Some embodiments provide enhanced UE identity information within the resource allocation message for enabling a communications device to determine, based on the resource allocation message, that it is not required to attempt to decode the signals transmitted using the indicated allocated resources. In comparison with conventional techniques, the enhanced UE identity information may reduce a possibility that the communications device incorrectly determines, based on the provided identity information, that it is required to attempt to decode the signals transmitted using the indicated allocated resources.

In other words, the enhanced UE identity information can reduce a probability of a false positive identity match for the communications device.

Example embodiments of the present technique will be described in more detail, with reference to the accompanying figures.

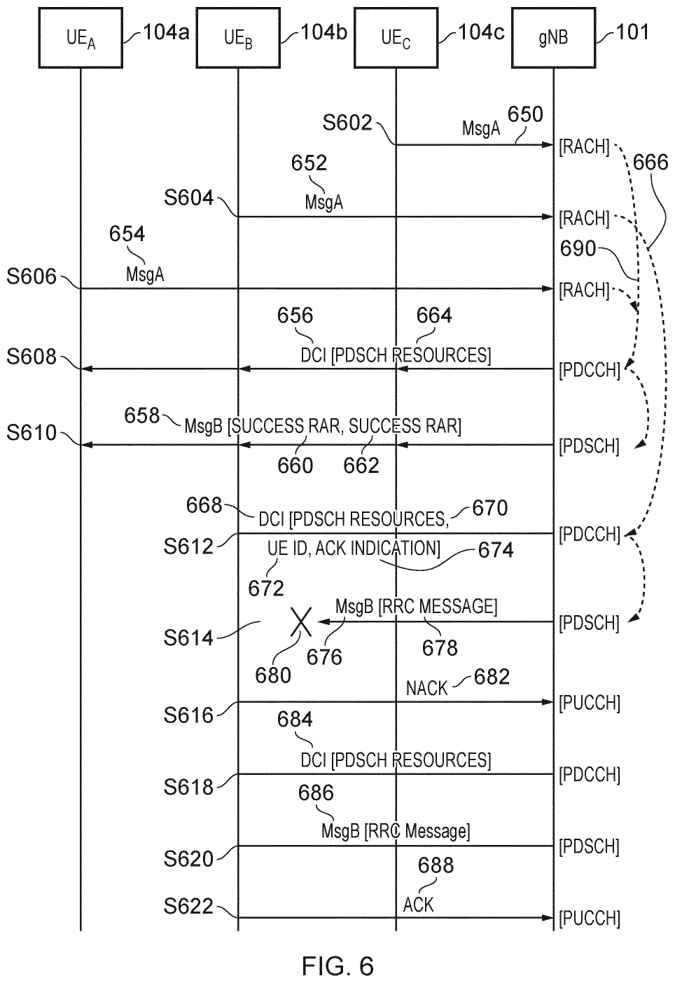

FIG. 6 illustrates a message sequence chart showing transmissions by the base station 101 and communication devices 104a, 104b, 104c, in accordance with the embodiments of the present technique.

The sequence in FIG. 6 begins at step S602, in which a third communications device 104c transmits a MsgA 650 to the base station 101 using a random access channel (RACH).

Independently, a second communications device 104b at step S604 transmits a second MsgA 652 to the base station 101 using a random access channel Similarly, at step S606, a first communications device 104a transmits a third MsgA 654 to the base station 101.

In FIG. 6, the random access transmissions at steps S602, S604 and S606 are shown as separate and non-overlapping. However, in some embodiments, two or more of these may be using the same RACH resources and/or may comprise a same random access preamble.

In the example of FIG. 6 each of the first, second, and third MsgA transmissions 650, 652, 654 are received and decoded correctly by the base station 101. In the example of FIG. 6, the base station 101 determines that responses to the first and third MsgAs 650, 654 may be combined in a single MsgB 658. For example, both responses may be ‘success’ random access response (“successRAR”) messages.

Accordingly, the base station 101 forms the first MsgB 658 comprising a first success random access response 660, directed to the first communications device 104a, and a second success random access response 662, directed to the third communications device 104c. At step S608, the base station 101 transmits first downlink control information (DCI) 656 comprising an indication 664 of downlink communications resources allocated for the transmissions of the first MsgB 658. The allocated communications resources may be on a physical downlink shared channel (PDSCH). The DCI 656 may be transmitted using a physical downlink control channel (PDCCH). As indicated by the arrow 690, the DCI 656 is transmitted in response to the first and third MsgAs 650, 654.

The DCI 656 may comprise an indication of a UE identity, which may not be unique, and may be derived based on communications resources used for the transmissions of the first and third MsgAs 650, 654. For example, the first DCI 656 may be encoded using a MsgB-RNTI calculated as described above in accordance with conventional techniques. As described above, in some embodiments it may be a condition of including both of the random access responses 660, 662 in the same MsgB 658 that the parameters of the MsgA transmissions, which are used for determining the RNTI for the DCI 656, are the same for both of the first and third MsgAs 650, 654.

Since both the first and third communications devices 104a, 104c derive the same identity, both the first and third communications devices 104a, 104c (correctly) consider that the first DCI 656 is addressed to them.

Subsequently at step S610, the base station 101 transmits the first MsgB 658 comprising the first success random access response 660 and the second success random access response 662, using the resources indicated in the first DCI 656.

If the second MsgA 652 was also transmitted using communications resources whose parameters result in the same MsgB-RNTI as used to encode the first DCI 656, then it may (incorrectly) determine that the first DCI 656 is addressed to it, and may attempt to decode the first MsgB 658. However, as described above, it will recognise that neither of the successRARs contained therein are addressed to it, based on the temporary identity transmitted in the second MsgA 652 not being present in either.

In the example of FIG. 6 the base station 101 determines that it is unable to include in the first MsgB 656 a response to the second communications device 104b. That is, the base station 101 determines that it is not able to include in the first MsgB 658 a response to the second MsgA 652 transmitted at step S604. This determination may be based on a determination that the response to the second MsgA 652 comprises data which is to be reliably transmitted to the second communications device 104b. Accordingly, the base station 101 determines that acknowledgment information is to be requested from the second communications device 104b in respect of the response transmitted by the base station 101 in response to the second MsgA 652.

As described above, in such cases it is not possible for the response to the second MsgA 652 to be multiplexed together with responses to other MsgA's such as the first MsgA 650 and the third MsgA 654.

Therefore, as indicated by the dashed arrow 666, the base station 101 responds to the second MsgA 652 by transmitting at step S612 a second DCI 668 comprising an indication of PDSCH resources 670, a UE identity 672 corresponding to the second communications device 104b, and an acknowledgment indication 674. Further details of the UE identity 672 are provided elsewhere in the present description.

The acknowledgment indication 674 indicates to the second communications device 104b that the base station 101 is requesting acknowledgment information such as a positive acknowledgment (ACK) or a negative acknowledgment (NACK) to be transmitted to indicate a reception status of the MsgB which is to be transmitted using the communications resources indicated by the PDSCH resource indication 670. Further details of the acknowledgement indication 674 are described elsewhere in the present description.

At step S614, the base station 104 transmits a second MsgB 676 comprising an RRC message 678 to the second communications device 104b, using the PDSCH communications resources indicated in the second DCI 668.

Upon receiving the second DCI 668, the second communications device 104b determines that it is addressed to it, based on the UE identity 672. In response, it attempts to decode the second MsgB 676 transmitted at step S614 using the downlink communications resources indicated in the second DCI 668.

As represented by the ‘X’ 680 in the message sequence chart, the second communications device 104b fails to correctly receive and decode the second MsgB 676. In response to the acknowledgment indication 674 and the failure to receive and decode the transmission using the PDSCH resources indicated in the second DCI 668, then at step S616, the second communications device 104b transmits a negative acknowledgment (NACK) 682 to the base station 101. The NACK 682 may be transmitted using Physical Uplink Control Channel, PUCCH.

In accordance with conventional acknowledgment techniques such as hybrid automatic repeat request (HARQ) the second communications device 104b may, at step S614, store soft-decoded bits corresponding to signals received on the allocated PDSCH communication resources indicated in the second DCI 668.

In response to receiving the NACK 682, the base station 101 allocates further communication resources for a retransmission of the second MsgB 676. At step S618, the base station 101 transmits a third DCI 684 comprising an indication of PDSCH resources for a retransmission of the second MsgB 676. At step S620, the base station 101 transmits a retransmission 686 of the second MsgB 676.

Following the transmission at step S620, the second communications device 104b may retrieve the stored soft-decoded bits which were stored after the attempt to decode the initial transmission of the MsgB 676 at step S614. These soft-decoded bits may be used together with received decoded bits corresponding to signals received using the PDSCH communication resources indicated in the third DCI 684 in order to improve a probability of successfully decoding the retransmitted MsgB 686.

In the example of FIG. 6, following step S620 the second communications device 104b successfully decodes the MsgB based on the retransmitted MsgB 686. The second communications device 104b may obtain the RRC message 678 from the decoded PDSCH resources. In addition, the communications device 104b may obtain one or more of its contention resolution identity, C-RNTI, and Timing Advance (TA) from the decoded MsgB. At the second communications device 104b, the 2-step RACH procedure is complete.

At step S622, in response to determining that the MsgB has been successfully decode, the second communications device 104b transmits a positive acknowledgment (ACK) 688 to the base station 101.

In response to receiving the ACK 688, the base station 101 determines that the contents of the MsgB 676 (retransmitted in the MsgB 686) have been successfully received and decoded by the second communications device 104b, and in response refrains from scheduling further retransmissions of the data.

UE Identity

In some embodiments, the UE identity 672 may be a MsgB-RNTI calculated as described above, based on the RACH resources used at step S604 for the transmission of the second MsgA 652, and used to encode the second DCI 668.

Alternatively, in some embodiments, the UE identity 672 may be based on one or both of a preamble index corresponding to the random access preamble used for the transmission of the second MsgA 652, and an index corresponding to a DMRS (demodulation reference signal) port/sequence that the communication device used for transmitting the data part of MsgA on uplink shared resources (e.g. PUSCH).

For example, in some embodiments, the RNTI used to encode the second DCI 668 comprises an enhanced MsgB-RNTI, which is calculated based on one or both of the preamble index and the DMRS (demodulation reference signal) port/sequence index.

In some embodiments, the enhanced MsgB-RNTI (MsgB-RNTI′) is calculated as:
MsgB-RNTI′=1+s_id+
   14×t_id+
   14×80×f_id+
   14×80×8×preamble_id+
   14×80×8×64×port_id+
   14×80×8×64×4×ul_carrier_id

where preamble_id is the Random Access Preamble Identifier or index that identifies the transmitted preamble (0≤preamble_id<64), port_id is the index associated with the DMRS port/Sequence used for the PUSCH transmission portion of the MsgA transmission (0≤port_id<4).

In such embodiments, the second communications device 104b monitors the downlink control channel for DCI transmissions using the enhanced MsgB-RNTI. In some such embodiments, the second communications device 104b additionally monitors the downlink control channel for DCI transmissions using the conventional MsgB-RNTI.

In some embodiments, a DCI may comprise a UE identity which is determined according to a first predetermined equation or rule when the DCI allocates resources for a response to multiple MsgAs, and is which is determined according to a second predetermined equation or rule when the DCI allocates resources for a response to a single MsgA. Preferably, when the UE identity is determined according to the second equation or rule, a probability that the same UE identity may be determined in respect of multiple MsgA transmissions (such that multiple communications devices may determine that the DCI is in response to their respective MsgA transmissions) is lower than when determined according to the first equation or rule.

In some embodiments, a DCI may comprise a UE identity which is a value, such as an RNTI, from within a first range when the DCI allocates resources for a response to multiple MsgAs, and is a value from a second range when the DCI allocates resources for a response to a single MsgA.

In some embodiments, the UE identity 672 comprises an indication of one or both of the preamble index and the DMRS (demodulation reference signal) port/sequence index, within the body of the DCI.

For example, in accordance with a conventional DCI format, there may be reserved bits (i.e. bits whose value has no meaning in a particular version of a standard), such as defined in section 7.3.1.2.1 of [8]:
Frequency domain resource assignment
Time domain resource assignment—4 bits as defined in Subclause 5.1.2.1 of [9]
VRB-to-PRB mapping—1 bit according to Table 7.3.1.1.2-33
Modulation and coding scheme—5 bits as defined in Subclause 5.1.3 of [9], using Table 5.1.3.1-1
TB scaling—2 bits as defined in Subclause 5.1.3.2 of [9]
Reserved bits—16 bits

In some embodiments, one or more bits of the DCI payload, such as those which are conventionally ‘reserved’, may comprise an indication of the one or both of the preamble index and the DMRS (demodulation reference signal) port/sequence index.

In some embodiments, a further binary bit may be used to indicate the presence of the additional index/indices.

For example, a portion of the payload may be specified as:
additional parameters: 1 bit (set to a first value to indicate the existence of additional parameters, and to a second value to indicate the absence of additional parameters);
RAPID (Random Access Preamble index)—6 bits according to ra-Preamblelndex
DMRS Port/sequence index—2 bits

In some such embodiments, the RNTI used to encode the DCI may be based on communications resources used for the RACH transmission, such as in the conventional MsgB-RNTI.

Because the enhanced MsgB-RNTI uses additional parameters, the likelihood of confusion when using the enhanced MsgB-RNTI is decreased. Similarly, the likelihood of confusion is decreased when the additional parameters described above are included in the payload of the DCI. That is, the probability that a communications device incorrectly determines that a DCI allocates communications resources for a response to its random access transmission is decreased. Accordingly, power consumption for such communications devices is reduced, because they do not need to decode the MsgB transmitted using the allocated resources in order to determine that the MsgB does not include a response to their MsgA.

Acknowledgement Indication

In some embodiments, the acknowledgement indication 674 comprises the presence of the UE identity 672 indicated in a pre-determined manner. For example, the acknowledgement indication 674 may be implicitly indicated by the encoding of the DCI using an enhanced MsgB-RNTI as described above. Alternatively, the presence of fields indicating one or both of the preamble index and the DMRS (demodulation reference signal) port/sequence index within the DCI payload may implicitly indicate the acknowledgement indication 674.

In some embodiments, the acknowledgement indication 674 may be explicitly indicated within the DCI. For example, the acknowledgement indication 674 may correspond to the setting of the additional parameters indication within the DCI payload to the first predetermined value, or may more generally correspond to the setting of one or more bits to a predetermined value to indicate the presence of the acknowledgement indication.

In some embodiments, inclusion of the acknowledgement indication 674 comprises the use of an RNTI to encode the DCI, where the RNTI is selected from a first range, different from a second range used when the acknowledgement indication 674 is not present. In some embodiments, the enhanced MsgB-RNTI may be calculated (e.g. by the use of a pre-determined offset) in order to ensure that it results in a value which is within the first range. In some embodiments, the first range is a range within which a conventional MsgB-RNTI may fall.

The inclusion of an acknowledgement indication in the resource allocation message (such as the DCI) enables a communications device which receives the resource allocation message but fails to decode the corresponding data transmitted in the resources allocated by the resource allocation message, to be aware that the base station requests an indication (e.g. ACK/NACK) in respect of the receive status of the data. Accordingly, a NACK can be transmitted in order to indicate to the base station that a retransmission is required.

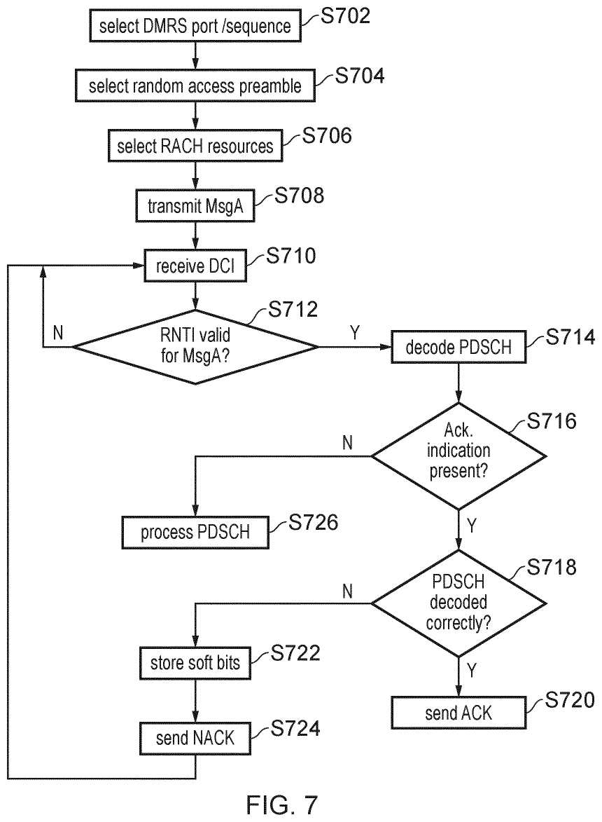

FIG. 7 illustrates a process flow chart for a process carried out by a communications device in accordance with embodiments of the present technique.

Prior to initiating this process, the communications device 104 determines that it need to initiate a transmission of uplink data in accordance with a two-step procedure.

The process illustrated in FIG. 7 starts at S702, in which the communications device selects a DMRS (demodulation reference signal) port/sequence for a transmission of a data part of a MsgA on a shared uplink channel (e.g. PUSCH) as a first message in the two-step procedure. The process continues at step S704, in which the communications device selects a random access preamble. At step S706, the communications device 104 selects communications resources of a random access channel, such as of a PRACH, for the transmission of the random access .

At step S708, the communication device 104 transmits a MsgA using the selected RACH and PUSCH resources. The MsgA comprises the preamble selected at step S704 transmitted using the select RACH resources and data transmitted using PUSCH resources with DMRS having port/sequence parameters selected at step S702.

At step S710, the communications device 104 receives downlink control information (DCI) on a PDCCH. At step S712, the communications device 104 determines whether the DCI received at step S710 comprises an RNTI which corresponds to the MsgA transmitted step S708 (referred to herein as a ‘valid’ RNTI). If it does not, then control returns to step S710.

In some embodiments, a valid RNTI may be a conventional MsgB-RNTI, as described above, and in some embodiments, a valid RNTI may be an enhanced MsgB-RNTI as described above.

In some embodiments, there may be multiple valid RNTI values with which a response to a given MsgA transmission may be transmitted. That is, the base station 101 may transmit a response (RAR) to the communications device 104 using one of a plurality of valid RNTI values. For example, where the RAR is sent in a MsgB comprising multiple RAR messages for multiple communications devices, a conventional MsgB-RNTI may be used. On the other hand, where the RAR is sent only to a single communications device, and/or where acknowledgement information is requested, an enhanced MsgB-RNTI may be used.

In some embodiments, the C-RNTI may be a valid RNTI, for example if the MsgA included the C-RNTI.

If at step S712, it is determined that the RNTI in the received DCI corresponds to the MsgA transmitted by the communications device 104 (i.e. the RNTI is a valid RNTI), then control passes to step S714.

In some embodiments, at (or after) step S712, the communications device 104 may additionally determine whether or not parameters within the DCI identify the communications device 104. For example, as described above, the DCI may comprise additional parameters, such as preamble index and/or DMRS slot/sequence index, which correspond respectively to the preamble and DMRS used for the MsgA transmission at step S708. If the communications device determines that such parameters are present and that they do not correspond to the MsgA transmitted at step S708, then control may return to step S710. In particular, in some embodiments, the communications device refrains from decoding signals received on the PDSCH communication resources indicated by the DCI received at step S710.

In step S714, the communications device 104 decodes the signals received on the PDSCH communication resources indicated by the DCI received at step S710.

At step S716, the communications device determines whether the DCI received at step S710 includes an acknowledgement indication. As described above, the acknowledgement indication may comprise the use of a particular RNTI value (such as the enhanced MsgB-RNTI), an implicit indication within the DCI payload (such as the presence of additional parameters), or an explicit indication within the DCI payload.

If no acknowledgement indication is present, then the PDSCH is processed in a conventional manner at step S726. For example the PDSCH signals may be decoded to determine whether the RACH procedure comprising the transmission of the MsgA in step S708 was successful, or whether the RACH procedure is to result in a fall back procedure to a four step RACH procedure, or whether the RACH procedure has failed.

If at step S716 it is determined that the DCI received at step S710 includes the acknowledgment indication, then control passes to step S718. In step S718 it is determined whether the PDSCH signals received at Step S714 were decoded correctly and without error. If the PDSCH signals were decoded correctly then control passes to step S720, in which the communications device 104 transmits a positive acknowledgment (ACK) message to the base station 101 and the process ends. If at step S718 it is determined that the PDSCH signals were not decoded correctly then control passes to step S722 in which the communications device 104 stores the soft bits resulting from the attempted PDSCH decoding at step S714. At step S724, the communications device 104 transmits a negative acknowledgment (NACK) to the base station 101. Control may then return to step S710 to monitor for a further DCI allocating down in communication resources for a retransmission of the random access response message.

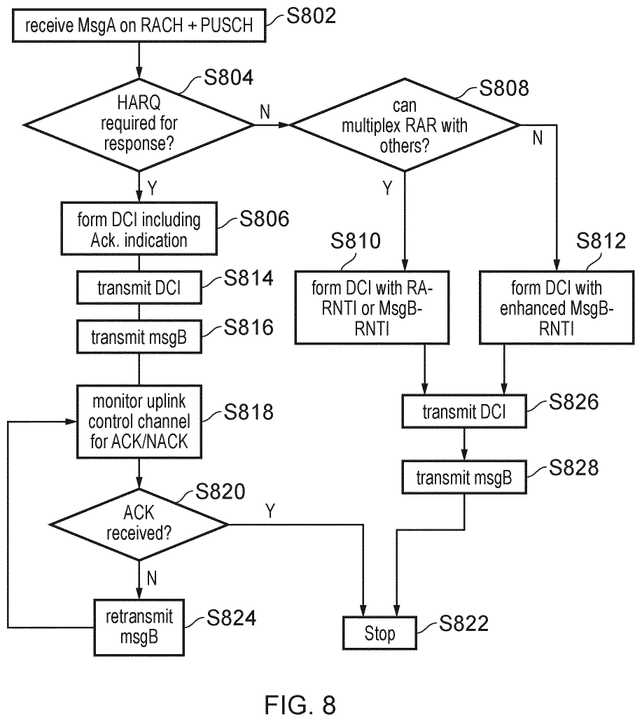

FIG. 8 illustrates a process for a base station, such as the base station 101, in accordance with embodiments of the present technique.

The process starts at step S802 in which the base station 101 receives a MsgA transmitted by a communications device, such as the communications device 104. As described above, this comprises a portion transmitted on RACH, and a portion transmitted on shared uplink resources (e.g. PUSCH).

In response, at step S804, the base station 101 determines the contents of a random access response and determines whether the response requires reliable delivery to the communications device 101. If it does, the control passes to step S806. If it does not, then control passes to step S808.

At step S808, the base station 101 determines whether the random access response to be transmitted in response to the MsgA received at step S802 can be multiplexed together with random access responses (RARs) to other MsgAs received from other communications devices.

If not (e.g. because there are no MsgAs for which a RAR transmission is pending), then control passes to step S812. If merging is possible, then control passes to step S810.

At step S806, the base station 101 forms downlink control information comprising an indication of downlink communications resource and the acknowledgement indication, to indicate to the communications device 104 that acknowledgement information is to be transmitted in respect of the data transmitted using the indicated downlink communications resources.

The DCI formed in step S806 also comprises a valid RNTI corresponding to the MsgA received in step S802. For example, the DCI may be the enhanced MsgB-RNTI described above. In some embodiments, the DCI comprises an indication of additional parameters, such as the preamble index of the MsgA received in step S802, and/or the DMRS port/sequence index associated with the DMRS port/sequence parameters used for the transmission of that part of the MsgA which was transmitted on the shared uplink channel A plurality of DMRS port/sequence indices may be associated with respective DMRS port/sequence parameters in accordance with a pre-determined association, for example as specified in the relevant 3GPP standards documents and the association may be known to both the communications device and the base station.

In some embodiments, the acknowledgement indication comprises the presence of the additional parameters or the use of the enhanced MsgB-RNTI.

Preferably, the RNTI (combined with the additional parameters, if included) is such that it is very unlikely that two or more communications device both consider that the DCI allocates resources for a transmission in response to a MsgA transmission by the respective communications device.

Following step S806, control passes to step S814 and the DCI is transmitted, for example using a downlink control channel such as PDCCH. Control then passes to step S816, in which the MsgB comprising the random access response (RAR) to the MsgA received in step S802 is transmitted, using the communications resources indicated in the DCI transmitted in step S814.

Subsequently, in step S818, the base station 101 monitors communications resources associated with an uplink control channel for receiving acknowledgement information transmitted by the communications device 101. In step S820, the base station 101 determines whether a positive acknowledgement has been received in respect of the preceding MsgB transmission. If a positive acknowledgement has been received, then the process ends at step S822.

If a negative acknowledgement (or in some embodiments, no positive acknowledgement) is received at step S818, then control passes to step S824 and the MsgB is retransmitted. The retransmission may be broadly in accordance with conventional HARQ procedures. For example, the encoding may comprise puncturing which may be different from puncturing used in a previous (e.g. the initial) transmission of the MsgB. This (or other encoding techniques) may be used to improve a probability that the communications device 101, using a combination of soft-decoded bits generated in respect of a previous transmission, and soft-decoded bits generated in respect of the present retransmission, is able to decode the MsgB correctly.

After the retransmission of the MsgB at step S824, control returns to step S818.

Returning to the steps following step S808, at step S810 and step S812, a DCI is formed comprising an allocation of communications resources for the transmission of a MsgB comprising a response for each of one (in step S810) or multiple (in step S812) MsgAs received by the base station 101. No acknowledgement indication is included in the DCI.

In step S810 the base station forms the DCI using a UE identity which is valid for each of the MsgAs for which a response is to be transmitted in the allocated resources. For example, the UE identity may be a predetermined RA-RNTI, or a conventional MsgB-RNTI.

Control then passes to step S826, in which the DCI is transmitted using, for example, a control channel Subsequently at step S828, using the resources indicated in the DCI, the MsgB comprising the multiple

RARs (or, where step S828 follows step S812, a single RAR) is transmitted. Because no acknowledgement indication was included in the DCI, no acknowledgement information is transmitted in response to the MsgB and the process then ends.

In step S812, the base station 101 forms the DCI using an RNTI which is valid for the single MsgA to which the MsgB is a response. The UE identity for the DCI may comprise, for example, an enhanced MsgB-RNTI in embodiments where the use of the enhanced MsgB-RNTI does not act as the acknowledgement indication as described in step S806. In other words, any suitable RNTI may be used provided it does not implicitly indicate that an acknowledgement is to be transmitted by the communications device in respect of the MsgB transmission. In some embodiments, the UE identity may comprise the inclusion of additional parameters within the DCI payload, provided that in that embodiment, the inclusion of additional parameters is not itself the acknowledgement indication as used in step S806.

The use of the enhanced MsgB-RNTI and/or other additional parameters, or more generally, the use of more accurate identification within the DCI may reduce power consumption of another communications device. This is because the other communications device can determine that the DCI does not allocate resources for a MsgB transmission comprising a response to its MsgA, and can thus refrain from attempting to decode the MsgB transmission. The use of the additional parameters may reduce the probability that the resulting DCI incorrectly appears (to the other communications device) to indicate that the following MsgB comprises a response to its MsgA.

After step S812, control passes to step S826 as described above.

Thus, in some embodiments, the use of more targeted identity information in a DCI increases the possibility that communications devices, to which a MsgB is not addressed, do not attempt to decode the MsgB.

Additionally or alternatively, in some embodiments, the inclusion of an acknowledgement indication in the DCI ensures that acknowledgement information is transmitted by a communications device to which a MsgB is directed, even if the communications device fails to successfully decode the MsgB, thereby enabling reliable delivery of data to the communications device.

In some embodiments, the use of the more targeted identity information is itself the acknowledgement indication (or part thereof), recognising that the acknowledgement indication is preferably only included where the MsgB comprises a single RAR (directed to a single communications device), thus providing an efficient means of providing reliable delivery of data to a single communications device.

In the processes illustrated in FIG. 7 and FIG. 8, in some embodiments one or more steps may be re-ordered, modified or omitted.

For example, in some embodiments, step S808 and step S812 of the process of FIG. 8 are omitted, and control may pass directly from step S804 to S812, in which case the DCI may be formed substantially in the same manner, regardless of whether one or more RARs are to be included in the MsgB. In such embodiments, the RNTI used to encode the DCI must be valid in respect of each of the MsgA transmissions for which a RAR is provided. For example, the DCI may be a pre-determined RA-RNTI.

It will be appreciated that the processes of FIG. 7 and FIG. 8 may comprise further steps not shown, such as steps of a RACH fallback procedure, a RACH failure procedure (which may comprise a re-starting of the process of FIG. 7), or further data transfer. The process may further comprise a state change for the communications device, such as a transition from an idle or inactive state to a connected state.

Similarly, the message sequence chart of FIG. 6 is for the purpose of clearly describing aspects of the present techniques. In some embodiments, one or more of the steps, messages or communications devices shown in FIG. 6 may be omitted, and additional steps, messages or communications devices may be present. For example, FIG. 6 shows the transmission of a MsgA as a single RACH transmission; that portion of the MsgA which is transmitted on PUSCH is not shown for conciseness.

Thus there has been described a method of operating a communications device in a wireless communications network, the method comprising: transmitting a random access message on a wireless access interface, the random access message comprising a selected random access preamble and a transmission on a shared channel, the shared channel transmission using a demodulation reference signal (DMRS) in accordance with one or more selected DMRS parameters, receiving a resource allocation message, the resource allocation message comprising an indication that the resource allocation message was transmitted in response to a random access message and an indication of downlink communications resources allocated for the transmission of a random access response message, receiving signals transmitted using the allocated downlink communications resources, determining that the resource allocation message identifies the communications device, and in response to determining that the resource allocation message identifies the communications device, decoding the signals transmitted using the allocated downlink communications resources, wherein the resource allocation message comprises an indication of the identity of the communications device based on one or more of an index associated with the selected random access preamble and the one or more selected DMRS parameters.

There has also been disclosed a method of operating a communications device in a wireless communications network, the method comprising: transmitting a random access message comprising a selected random access preamble, receiving a resource allocation message, the resource allocation message comprising: an indication that the resource allocation message was transmitted in response to a random access message, an indication of downlink communications resources allocated for the transmission of a random access response message, an acknowledgement indication, the acknowledgement indication requesting that acknowledgement information is transmitted by the communications device to indicate a received status of a random access response message, and an indication of an identity of the communications device, receiving signals transmitted using the allocated downlink communications resources, the signals representing data, determining that the resource allocation message identifies the communications device, in response to determining that the resource allocation identifies the communications device, decoding the signals transmitted using the allocated downlink communications resources to determine a receive status of the data, and in response to receiving the resource allocation message comprising the acknowledgement indication, transmitting acknowledgement information based on the determined receive status.

Corresponding communications devices, base stations and methods therefore, and circuitry for a communications device and circuitry for a base station have also been described.

It will be appreciated that while the present disclosure has in some respects focused on implementations in an LTE-based and/or 5G network for the sake of providing specific examples, the same principles can be applied to other wireless telecommunications systems. Thus, even though the terminology used herein is generally the same or similar to that of the LTE and 5G standards, the teachings are not limited to the present versions of LTE and 5G and could apply equally to any appropriate arrangement not based on

LTE or 5G and/or compliant with any other future version of an LTE, 5G or other standard.

It may be noted various example approaches discussed herein may rely on information which is predetermined/predefined in the sense of being known by both the base station and the communications device. It will be appreciated such predetermined/predefined information may in general be established, for example, by definition in an operating standard for the wireless telecommunication system, or in previously exchanged signalling between the base station and communications devices, for example in system information signalling, or in association with radio resource control setup signalling, or in information stored in a SIM application. That is to say, the specific manner in which the relevant predefined information is established and shared between the various elements of the wireless telecommunications system is not of primary significance to the principles of operation described herein.

It may further be noted various example approaches discussed herein rely on information which is exchanged/communicated between various elements of the wireless telecommunications system and it will be appreciated such communications may in general be made in accordance with conventional techniques, for example in terms of specific signalling protocols and the type of communication channel used, unless the context demands otherwise. That is to say, the specific manner in which the relevant information is exchanged between the various elements of the wireless telecommunications system is not of primary significance to the principles of operation described herein.

It will be appreciated that the principles described herein are not applicable only to certain types of communications device, but can be applied more generally in respect of any types of communications device, for example the approaches are not limited to URLLC/IIoT devices or other low latency communications devices, but can be applied more generally, for example in respect of any type of communications device operating with a wireless link to the communication network.

It will further be appreciated that the principles described herein are applicable not only to LTE-based or 5G/NR-based wireless telecommunications systems, but are applicable for any type of wireless telecommunications system that supports a dynamic scheduling of shared communications resources.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered paragraphs:

Paragraph 1. A method of operating a communications device in a wireless communications network, the method comprising: transmitting a random access message on a wireless access interface, the random access message comprising a selected random access preamble and a transmission on a shared channel, the shared channel transmission using a demodulation reference signal (DMRS) in accordance with one or more selected DMRS parameters, receiving a resource allocation message, the resource allocation message comprising an indication that the resource allocation message was transmitted in response to a random access message and an indication of downlink communications resources allocated for the transmission of a random access response message, receiving signals transmitted using the allocated downlink communications resources, determining that the resource allocation message identifies the communications device, and in response to determining that the resource allocation message identifies the communications device, decoding the signals transmitted using the allocated downlink communications resources, wherein the resource allocation message comprises an indication of the identity of the communications device based on one or more of an index associated with the selected random access preamble and the one or more selected DMRS parameters.

Paragraph 2. A method according to paragraph 1, wherein the resource allocation message identifies the communications device at least in part by a radio network temporary identity used to encode the resource allocation message.

Paragraph 3. A method according to paragraph 2, wherein the wireless access interface is based on orthogonal frequency division multiplexing (OFDM) and provides a physical random access channel (PRACH) on an uplink carrier, the random access message is transmitted using time and frequency communications resources corresponding to an occasion of the PRACH, and the radio network temporary identity is determined based on one or more of: an index of the first OFDM symbol of the PRACH occasion, an index of the first slot of the PRACH occasion in a system frame, a subcarrier spacing, an index of the PRACH occasion in the frequency domain, and the uplink carrier used.

Paragraph 4. A method according to paragraph 2 or paragraph 3, wherein the radio network temporary identity is determined based on the one or more of the selected random access preamble index and an index associated with the one or more selected DMRS parameters.

Paragraph 5. A method according to any of paragraphs 1 to 4, wherein the resource allocation message comprises an indication of the one or more of the index associated with the selected random access preamble and the index associated with the one or more selected DMRS parameters.

Paragraph 6. A method according to any of paragraphs 1 to 5, the method comprising receiving a second resource allocation message, determining that the second resource allocation message does not identify the communications device, and in response to the determining, refraining from decoding signals received using downlink communications resources allocated by the second resource allocation message.

Paragraph 7. A method of operating a communications device in a wireless communications network, the method comprising: transmitting a random access message comprising a selected random access preamble, receiving a resource allocation message, the resource allocation message comprising: an indication that the resource allocation message was transmitted in response to a random access message, an indication of downlink communications resources allocated for the transmission of a random access response message, an acknowledgement indication, the acknowledgement indication requesting that acknowledgement information is transmitted by the communications device to indicate a received status of a random access response message, and an indication of an identity of the communications device, receiving signals transmitted using the allocated downlink communications resources, the signals representing data, determining that the resource allocation message identifies the communications device, in response to determining that the resource allocation identifies the communications device, decoding the signals transmitted using the allocated downlink communications resources to determine a receive status of the data, and in response to receiving the resource allocation message comprising the acknowledgement indication, transmitting acknowledgement information based on the determined receive status.

Paragraph 8. A method according to paragraph 7, wherein when the decoding is unsuccessful, the acknowledgement information indicates that the data was not correctly received.

Paragraph 9. A method according to paragraph 7 or paragraph 8, wherein when the decoding is successful, the acknowledgement information indicates that the data was correctly received.

Paragraph 10. A method according to paragraph 8 or paragraph 9, the method comprising determining that the data has not been decoded successfully, in response to receiving the resource allocation message comprising the acknowledgement indication and determining that the data has not been decoded successfully, storing soft decoded bits obtained by decoding the data, receiving signals representing a retransmission of the data, and decoding the data based on the stored soft decoded bits and the received signals representing the retransmission of the data.

Paragraph 11. A method according to any of paragraphs 7 to 10, wherein the resource allocation message comprises a temporary identifier, and the temporary identifier comprises the acknowledgement indication.

Paragraph 12. A method according to paragraph 11, wherein when the temporary identifier comprises the acknowledgement indication, the temporary identifier is within a first range of values, and when the temporary identifier does not comprise the acknowledgement indication, the temporary identifier is within a second first range of values.

Paragraph 13. A method according to paragraph 11 or paragraph 12, wherein the random access message comprises a transmission on a shared channel, the shared channel transmission using a demodulation reference signal (DMRS) in accordance with one or more selected DMRS parameters, and the temporary identifier is determined based on the one or more of an index associated with the random access preamble and an index associated with the one or more selected DMRS parameters.

Paragraph 14. A method according to paragraph 13, wherein when the temporary identifier comprises the acknowledgement indication, the temporary identifier is determined based on the one or more of the preamble index and the index associated with the one or more selected DMRS parameters, and when the temporary identifier does not comprise the acknowledgement indication, the temporary identifier is not based on either the preamble index or the index associated with the one or more selected DMRS parameters.

Paragraph 15. A method according to any of paragraphs 7 to 14, wherein the acknowledgement indication comprises the presence in the resource allocation message of an indication of one or more of the preamble index and the index associated with the one or more selected DMRS parameters.

Paragraph 16. A method according to any of paragraphs 7 to 15, wherein the acknowledgement indication comprises one or more bits set to a predetermined value.

Paragraph 17. A method according to any of paragraphs 7 to 16, wherein the data comprises radio resource control (RRC) signalling.

Paragraph 18. A method according to any of paragraphs 7 to 17, wherein the one or more selected DMRS parameters comprise one or more of an antenna port and a modulation sequence.

Paragraph 19. A method of operating a base station in a wireless communications network, the method comprising: receiving a random access message transmitted by a communications device, determining that data requiring reliable transmission is to be included in a random access response message, in response to the determining that data requiring reliable transmission to the communications device is to be included in the response to the random access message, forming a resource allocation message comprising: an acknowledgement indication, the acknowledgement indication requesting that acknowledgement information is transmitted by the communications device to indicate the received status of the random access response message, an indication of downlink communications resources allocated for the transmission of the random access response message, and an indication of an identity of the communications device, transmitting the resource allocation message, and transmitting the random access response message including the data requiring reliable transmission using the allocated downlink communications resources.

Paragraph 20. A method according to paragraph 19, wherein the resource allocation message comprises a temporary identifier, and the temporary identifier comprises the acknowledgement indication.

Paragraph 21. A method according to paragraph 20, wherein when the temporary identifier comprises the acknowledgement indication, the temporary identifier is within a first range of values, and when the temporary identifier does not comprise the acknowledgement indication, the temporary identifier is within a second first range of values.

Paragraph 22. A method according to paragraph 20 or paragraph 21, wherein the random access message comprises a transmission on a shared channel, the shared channel transmission using a demodulation reference signal (DMRS) in accordance with one or more selected DMRS parameters, and the temporary identifier is determined based on the one or more of a preamble index of the random access message and an index associated with the one or more selected DMRS parameters.

Paragraph 23. A method according to paragraph 22, wherein when the temporary identifier comprises the acknowledgement indication, the temporary identifier is determined based on the one or more of the preamble index and the index associated with the one or more selected DMRS parameters, and when the temporary identifier does not comprise the acknowledgement indication, the temporary identifier is not based on either the preamble index or the index associated with the one or more selected DMRS parameters.

Paragraph 24. A method according to any of paragraphs 19 to 23, wherein the acknowledgement indication comprises the presence in the resource allocation message of an indication of one or more of the preamble index and the index associated with the one or more selected DMRS parameters.

Paragraph 25. A method according to any of paragraphs 19 to 24, wherein the acknowledgement indication comprises one or more bits set to a predetermined value.

Paragraph 26. A method according to any of paragraphs 19 to 25, the method comprising receiving the acknowledgement information, and when the acknowledgement information indicates that the data was not decoded correctly, retransmitting the data.

Paragraph 27. A method according to any of paragraphs 7 to 25, wherein the data comprises radio resource control (RRC) signalling.

Paragraph 28. A method of operating a base station in a wireless communications network, the method comprising: receiving a random access message on a wireless access interface, the random access message comprising a selected random access preamble and a transmission on a shared channel, the shared channel transmission using a demodulation reference signal (DMRS) in accordance with one or more selected DMRS parameters, determining that a response message to be transmitted is to comprise a response to the random access message and no response to any other random access message, in response to receiving the random access message and the determining that the response message is to comprise a response to the random access message and no response to any other random access message, forming a resource allocation message, the resource allocation message comprising: an indication that the resource allocation message is in response to a random access message, an indication of downlink communications resources allocated for the transmission of the random access response message, and an indication of an identity of the communications device based on one or more of an index associated with the selected random access preamble and the one or more selected DMRS parameters, transmitting the resource allocation message, and transmitting the response message using the allocated downlink communications resources.

Paragraph 29. A method according to paragraph 28, wherein the resource allocation message identifies the communications device at least in part by a radio network temporary identity used to encode the resource allocation message.

Paragraph 30. A method according to paragraph 29, wherein the wireless access interface is based on orthogonal frequency division multiplexing (OFDM) and provides a physical random access channel (PRACH) on an uplink carrier, the random access message is transmitted using time and frequency communications resources corresponding to an occasion of the PRACH, and the radio network temporary identity is determined based on one or more of: an index of the first OFDM symbol of the PRACH occasion, an index of the first slot of the PRACH occasion in a system frame, a subcarrier spacing, an index of the PRACH occasion in the frequency domain, and the uplink carrier used.

Paragraph 31. A method according to paragraph 29 or paragraph 30, wherein the radio network temporary identity is determined based on the one or more of the selected random access preamble index and an index associated with the one or more selected DMRS parameters.

Paragraph 32. A method according to any of paragraphs 28 to 31, wherein the resource allocation message comprises an indication of the one or more of the index associated with the selected random access preamble and the index associated with the one or more selected DMRS parameters.

Paragraph 33. A communications device for operating in a wireless communications network, the communications device comprising a transmitter configured to transmit signals via a wireless access interface provided by an base station of the wireless communications network , a receiver configured to receive signals via the wireless access interface, and a controller configured to control the transmitter and the receiver so that the communications device is operable: to transmit a random access message on the wireless access interface, the random access message comprising a selected random access preamble and a transmission on a shared channel, the shared channel transmission using a demodulation reference signal (DMRS) in accordance with one or more selected DMRS parameters, to receive a resource allocation message, the resource allocation message comprising an indication that the resource allocation message was transmitted in response to a random access message and an indication of downlink communications resources allocated for the transmission of a random access response message, to receive signals transmitted using the allocated downlink communications resources, to determine that the resource allocation message identifies the communications device, and in response to determining that the resource allocation message identifies the communications device, to decode the signals transmitted using the allocated downlink communications resources, wherein the resource allocation message comprises an indication of the identity of the communications device based on one or more of an index associated with the selected random access preamble and the one or more selected DMRS parameters.

Paragraph 34. Circuitry for a communications device for operating in a wireless communications network, the circuitry comprising transmitter circuitry configured to transmit signals via a wireless access interface provided by an base station of the wireless communications network , receiver circuitry configured to receive signals via the wireless access interface, and controller circuitry configured to control the transmitter circuitry and the receiver circuitry so that the communications device is operable: to transmit a random access message on the wireless access interface, the random access message comprising a selected random access preamble and a transmission on a shared channel, the shared channel transmission using a demodulation reference signal (DMRS) in accordance with one or more selected DMRS parameters, to receive a resource allocation message, the resource allocation message comprising an indication that the resource allocation message was transmitted in response to a random access message and an indication of downlink communications resources allocated for the transmission of a random access response message, to receive signals transmitted using the allocated downlink communications resources, to determine that the resource allocation message identifies the communications device, and in response to determining that the resource allocation message identifies the communications device, to decode the signals transmitted using the allocated downlink communications resources, wherein the resource allocation message comprises an indication of the identity of the communications device based on one or more of an index associated with the selected random access preamble and the one or more selected DMRS parameters.

Paragraph 35. A communications device for operating in a wireless communications network, the communications device comprising a transmitter configured to transmit signals via a wireless access interface provided by an base station of the wireless communications network , a receiver configured to receive signals via the wireless access interface, and a controller configured to control the transmitter and the receiver so that the communications device is operable: to transmit a random access message comprising a selected random access preamble, to receive a resource allocation message, the resource allocation message comprising: an indication that the resource allocation message was transmitted in response to a random access message, an indication of downlink communications resources allocated for the transmission of a random access response message, an acknowledgement indication, the acknowledgement indication requesting that acknowledgement information is transmitted by the communications device to indicate a received status of a random access response message, and an indication of an identity of the communications device, to receive signals transmitted using the allocated downlink communications resources, the signals representing data, to determine that the resource allocation message identifies the communications device, in response to determining that the resource allocation identifies the communications device, to decode the signals transmitted using the allocated downlink communications resources to determine a receive status of the data, and in response to receiving the resource allocation message comprising the acknowledgement indication, to transmit acknowledgement information based on the determined receive status.

Paragraph 36. Circuitry for a communications device for operating in a wireless communications network, the circuitry comprising transmitter circuitry configured to transmit signals via a wireless access interface provided by an base station of the wireless communications network , receiver circuitry configured to receive signals via the wireless access interface, and controller circuitry configured to control the transmitter circuitry and the receiver circuitry so that the communications device is operable: to transmit a random access message comprising a selected random access preamble, to receive a resource allocation message, the resource allocation message comprising: an indication that the resource allocation message was transmitted in response to a random access message, an indication of downlink communications resources allocated for the transmission of a random access response message, an acknowledgement indication, the acknowledgement indication requesting that acknowledgement information is transmitted by the communications device to indicate a received status of a random access response message, and an indication of an identity of the communications device, to receive signals transmitted using the allocated downlink communications resources, the signals representing data, to determine that the resource allocation message identifies the communications device, in response to determining that the resource allocation identifies the communications device, to decode the signals transmitted using the allocated downlink communications resources to determine a receive status of the data, and in response to receiving the resource allocation message comprising the acknowledgement indication, to transmit acknowledgement information based on the determined receive status.

Paragraph 37. A base station for use in a wireless communications network, the base station providing a wireless access interface for communicating with a communications device, the base station comprising a transmitter configured to transmit signals to the communications device via the wireless access interface, a receiver configured to receive signals from the communications device, and a controller configured to control the transmitter and the receiver so that the base station is operable: to receive a random access message transmitted by a communications device, to determine that data requiring reliable transmission is to be included in a random access response message, in response to the determining that data requiring reliable transmission to the communications device is to be included in the response to the random access message, to form a resource allocation message comprising: an acknowledgement indication, the acknowledgement indication requesting that acknowledgement information is transmitted by the communications device to indicate the received status of the random access response message, an indication of downlink communications resources allocated for the transmission of the random access response message, and an indication of an identity of the communications device, to transmit the resource allocation message, and to transmit the random access response message including the data requiring reliable transmission using the allocated downlink communications resources.

Paragraph 38. Circuitry for a base station for use in a wireless communications network, the base station providing a wireless access interface for communicating with a communications device, the circuitry comprising transmitter circuitry configured to transmit signals to the communications device via the wireless access interface, receiver circuitry configured to receive signals from the communications device, and controller circuitry configured to control the transmitter circuitry and the receiver circuitry so that the base station is operable: to receive a random access message transmitted by a communications device, to determine that data requiring reliable transmission is to be included in a random access response message, in response to the determining that data requiring reliable transmission to the communications device is to be included in the response to the random access message, to form a resource allocation message comprising: an acknowledgement indication, the acknowledgement indication requesting that acknowledgement information is transmitted by the communications device to indicate the received status of the random access response message, an indication of downlink communications resources allocated for the transmission of the random access response message, and an indication of an identity of the communications device, to transmit the resource allocation message, and to transmit the random access response message including the data requiring reliable transmission using the allocated downlink communications resources.

Paragraph 39. A base station for use in a wireless communications network, the base station providing a wireless access interface for communicating with a communications device, the base station comprising a transmitter configured to transmit signals to the communications device via the wireless access interface, a receiver configured to receive signals from the communications device, and a controller configured to control the transmitter and the receiver so that the base station is operable: to receive a random access message on a wireless access interface, the random access message comprising a selected random access preamble and a transmission on a shared channel, the shared channel transmission using a demodulation reference signal (DMRS) in accordance with one or more selected DMRS parameters, to determine that a response message to be transmitted is to comprise a response to the random access message and no response to any other random access message, in response to receiving the random access message and the determining that the response message is to comprise a response to the random access message and no response to any other random access message, to form a resource allocation message, the resource allocation message comprising: an indication that the resource allocation message is in response to a random access message, an indication of downlink communications resources allocated for the transmission of the random access response message, and an indication of an identity of the communications device based on one or more of an index associated with the selected random access preamble and the one or more selected DMRS parameters, to transmit the resource allocation message, and to transmit the response message using the allocated downlink communications resources.

Paragraph 40. Circuitry for a base station for use in a wireless communications network, the base station providing a wireless access interface for communicating with a communications device, the circuitry comprising transmitter circuitry configured to transmit signals to the communications device via the wireless access interface, receiver circuitry configured to receive signals from the communications device, and controller circuitry configured to control the transmitter circuitry and the receiver circuitry so that the base station is operable: to receive a random access message on a wireless access interface, the random access message comprising a selected random access preamble and a transmission on a shared channel, the shared channel transmission using a demodulation reference signal (DMRS) in accordance with one or more selected DMRS parameters, to determine that a response message to be transmitted is to comprise a response to the random access message and no response to any other random access message, in response to receiving the random access message and the determining that the response message is to comprise a response to the random access message and no response to any other random access message, to form a resource allocation message, the resource allocation message comprising: an indication that the resource allocation message is in response to a random access message, an indication of downlink communications resources allocated for the transmission of the random access response message, and an indication of an identity of the communications device based on one or more of an index associated with the selected random access preamble and the one or more selected DMRS parameters, to transmit the resource allocation message, and to transmit the response message using the allocated downlink communications resources.

Further particular and preferred aspects of the present invention are set out in the accompanying independent and dependent claims. It will be appreciated that features of the dependent claims may be combined with features of the independent claims in combinations other than those explicitly set out in the claims.

### REFERENCES

[1] RP-182090, “Revised SID: Study on NR Industrial Internet of Things (IoT),” 3GPP RAN#81.

[2] Holma H. and Toskala A, “LTE for UMTS OFDMA and SC-FDMA based radio access”, John Wiley and Sons, 2009

[3] 3GPP TS 38.321, “Medium Access Control (MAC) protocol specification (Rel-15)”, v15.3.0

[4] 3GPP TS 38.300 V15.4.0

[5] 3GPP TS 38.321 “NR; Medium Access Control (MAC) protocol specification”, version 15.6.0

[6] 3GPP Tdoc R1-1907323 “Procedure for cross-slot scheduling technique”, Ericsson

[7] ETSI TS 136 213 V13.0.0 (2016-01)/3GPP TS 36.212 version 13.0.0 Release 13

[8] 3GPP TS 38.212 “NR; Multiplexing and channel coding”, version 15.6.0

[9] 3GPP TS 38.214 “NR; Physical layer procedures for data”, version 15.6.0

[10] 3GPP document RP-182894, “WID: 2-step RACH for NR,” RAN#82

[11] 3GPP document RP-182878, “NR-based Access to Unlicensed Spectrum”, RAN#82.

[12] 3GPP TS 38.211 “NR; Physical channels and modulation”, version 15.6.0

1. A method of operating a communications device in a wireless communications network, the method comprising:
transmitting a random access message on a wireless access interface, the random access message comprising a selected random access preamble and a transmission on a shared channel, the shared channel transmission using a demodulation reference signal (DMRS) in accordance with one or more selected DMRS parameters,
receiving a resource allocation message, the resource allocation message comprising an indication that the resource allocation message was transmitted in response to a random access message and an indication of downlink communications resources allocated for the transmission of a random access response message,
receiving signals transmitted using the allocated downlink communications resources,
determining that the resource allocation message identifies the communications device, and
in response to determining that the resource allocation message identifies the communications device, decoding the signals transmitted using the allocated downlink communications resources, wherein
the resource allocation message comprises an indication of the identity of the communications device based on one or more of an index associated with the selected random access preamble and the one or more selected DMRS parameters.

2. A method according to claim 1, wherein the resource allocation message identifies the communications device at least in part by a radio network temporary identity used to encode the resource allocation message.

3. A method according to claim 2, wherein
the wireless access interface is based on orthogonal frequency division multiplexing (OFDM) and provides a physical random access channel (PRACH) on an uplink carrier,
the random access message is transmitted using time and frequency communications resources corresponding to an occasion of the PRACH, and
the radio network temporary identity is determined based on one or more of:
an index of the first OFDM symbol of the PRACH occasion,
an index of the first slot of the PRACH occasion in a system frame,
a subcarrier spacing,
an index of the PRACH occasion in the frequency domain, and
the uplink carrier used.

4. A method according to claim 2, wherein the radio network temporary identity is determined based on the one or more of the selected random access preamble index and an index associated with the one or more selected DMRS parameters.

5. A method according to claim 1, wherein the resource allocation message comprises an indication of the one or more of the index associated with the selected random access preamble and the index associated with the one or more selected DMRS parameters.

6. A method according to claim 1, the method comprising
receiving a second resource allocation message,
determining that the second resource allocation message does not identify the communications device, and
in response to the determining, refraining from decoding signals received using downlink communications resources allocated by the second resource allocation message.

7. A method of operating a communications device in a wireless communications network, the method comprising:
transmitting a random access message comprising a selected random access preamble,
receiving a resource allocation message, the resource allocation message comprising:
an indication that the resource allocation message was transmitted in response to a random access message,
an indication of downlink communications resources allocated for the transmission of a random access response message,
an acknowledgement indication, the acknowledgement indication requesting that acknowledgement information is transmitted by the communications device to indicate a received status of a random access response message, and
an indication of an identity of the communications device,
receiving signals transmitted using the allocated downlink communications resources, the signals representing data,
determining that the resource allocation message identifies the communications device,
in response to determining that the resource allocation identifies the communications device, decoding the signals transmitted using the allocated downlink communications resources to determine a receive status of the data, and
in response to receiving the resource allocation message comprising the acknowledgement indication, transmitting acknowledgement information based on the determined receive status.

8. A method according to claim 7, wherein
when the decoding is unsuccessful, the acknowledgement information indicates that the data was not correctly received.

9. A method according to claim 7, wherein
when the decoding is successful, the acknowledgement information indicates that the data was correctly received.

10. A method according to claim 8, the method comprising
determining that the data has not been decoded successfully,
in response to receiving the resource allocation message comprising the acknowledgement indication and determining that the data has not been decoded successfully, storing soft decoded bits obtained by decoding the data,
receiving signals representing a retransmission of the data, and
decoding the data based on the stored soft decoded bits and the received signals representing the retransmission of the data.

11. A method according to claim 7, wherein the resource allocation message comprises a temporary identifier, and the temporary identifier comprises the acknowledgement indication.

12. A method according to claim 11, wherein
when the temporary identifier comprises the acknowledgement indication, the temporary identifier is within a first range of values, and
when the temporary identifier does not comprise the acknowledgement indication, the temporary identifier is within a second first range of values.

13. A method according to claim 11, wherein
the random access message comprises a transmission on a shared channel, the shared channel transmission using a demodulation reference signal (DMRS) in accordance with one or more selected DMRS parameters, and
the temporary identifier is determined based on the one or more of an index associated with the random access preamble and an index associated with the one or more selected DMRS parameters.

14. A method according to claim 13, wherein
when the temporary identifier comprises the acknowledgement indication, the temporary identifier is determined based on the one or more of the preamble index and the index associated with the one or more selected DMRS parameters, and
when the temporary identifier does not comprise the acknowledgement indication, the temporary identifier is not based on either the preamble index or the index associated with the one or more selected DMRS parameters.

15. A method according to claim 7, wherein
the acknowledgement indication comprises the presence in the resource allocation message of an indication of one or more of the preamble index and the index associated with the one or more selected DMRS parameters.

16. A method according to claim 7, wherein
the acknowledgement indication comprises one or more bits set to a predetermined value.

17. A method according to claim 7, wherein the data comprises radio resource control (RRC) signalling.

18. A method according to claim 7, wherein the one or more selected DMRS parameters comprise one or more of an antenna port and a modulation sequence.

19.-36. (canceled)

37. A base station for use in a wireless communications network, the base station providing a wireless access interface for communicating with a communications device, the base station comprising
a transmitter configured to transmit signals to the communications device via the wireless access interface,
a receiver configured to receive signals from the communications device, and
a controller configured to control the transmitter and the receiver so that the base station is operable:
to receive a random access message transmitted by a communications device,
to determine that data requiring reliable transmission is to be included in a random access response message,
in response to the determining that data requiring reliable transmission to the communications device is to be included in the response to the random access message, to form a resource allocation message comprising:
an acknowledgement indication, the acknowledgement indication requesting that acknowledgement information is transmitted by the communications device to indicate the received status of the random access response message,
an indication of downlink communications resources allocated for the transmission of the random access response message, and
an indication of an identity of the communications device,
to transmit the resource allocation message, and
to transmit the random access response message including the data requiring reliable transmission using the allocated downlink communications resources.

38.-40. (canceled)
